(19) United States
(12) Patent Application Publication
(10) Pub. No.: US 2024/0236158 A1
(43) Pub. Date: Jul. 11, 2024

(54) SYSTEM AND METHOD FOR DETERMINING THE STATE OF A TELEVISION

(71) Applicant: Verance Corporation, San Diego, CA (US)

(72) Inventors: Joseph M. Winograd, San Diego, CA (US); Patrick George Downes, Fremont, CA (US)

(21) Appl. No.: 18/518,086

(22) Filed: Nov. 22, 2023

Related U.S. Application Data
(60) Provisional application No. 63/482,575, filed on Jan. 31, 2023.
(60) Provisional application No. 63/427,450, filed on Nov. 22, 2022.

(51) Int. Cl. H04L 65/1073; H04L 65/1104; H04N 21/4363; H04N 21/443; H04N 21/8358

(52) U.S. Cl. CPC H04L 65/1073; H04L 65/1104; H04N 21/43635; H04N 21/4432; H04N 21/8358

(57) ABSTRACT

A system and method for tracking the state of a television in an HDMI environment using analysis of the bi-directional HDMI CEC channel. This information may be used to determine if the television has been turned on or off, and also to determine if a streaming media player has been selected for display. In response to a determination that the television has been turned off, or that another input has been selected for display on the television, the stream may be turned off or other actions may be taken. By turning off the stream when it is not being viewed, unnecessary network usage and power consumption is avoided. Another advantage of the disclosed system and method is that advertisers may avoid streaming ads that are not viewable.

### FIELD OF INVENTION

The present invention generally relates to determining the state of a television.

### BACKGROUND

This section is intended to provide a background or context to the disclosed embodiments that are recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

An HDMI interconnected home entertainment system (“HDMI System”) includes a Streaming Media Player (SMP) either connected directly to a TV, or connected to an intermediate Audio Video Receiver (AVR) or Soundbar which is connected to the TV, where the connections use HDMI interfaces. The SMP can stream media to the TV. The SMP currently has no reliable way to determine if the TV is on and has the SMP selected for display. Without this knowledge, a SMP can continue to stream media after the TV has been turned off or has selected another input to display. This can result in disadvantages for the user including excessive network usage and power consumption. It can also be a disadvantage for advertisers who are sponsoring the streams because their advertisements are not viewable.

### BRIEF DESCRIPTION OF THE DRAWINGS

FIG. 1 illustrates a block diagram of an HDMI system with a SMP, two other HDMI sources, and a TV in according with an exemplary embodiment.

FIG. 2 illustrates a block diagram of an HDMI system with a SMP, two other HDMI sources, an AVR and a TV in according with an exemplary embodiment.

FIG. 3 illustrates a set of operations that can be used to determine lastestAssrtdActiveSourcePhyAddr according with an exemplary embodiment.

FIG. 4 illustrates a set of operations that can be used to determine lastestRoutingChangdNewAddr according with an exemplary embodiment.

FIG. 5 illustrates a set of operations that can be used to determine lastestSeetStreamPathPhyAddr according with an exemplary embodiment.

FIG. 6 illustrates a set of operations that can be used to determine Get_fTVRenderingSMP( ) according with an exemplary embodiment.

FIG. 7 illustrates a sequence diagram of a session initiation protocol according with an exemplary embodiment.

FIG. 8 illustrates a sequence diagram of a session operation protocol according with an exemplary embodiment.

FIG. 9 illustrates a block diagram of a device that can be used for implementing various disclosed embodiments.

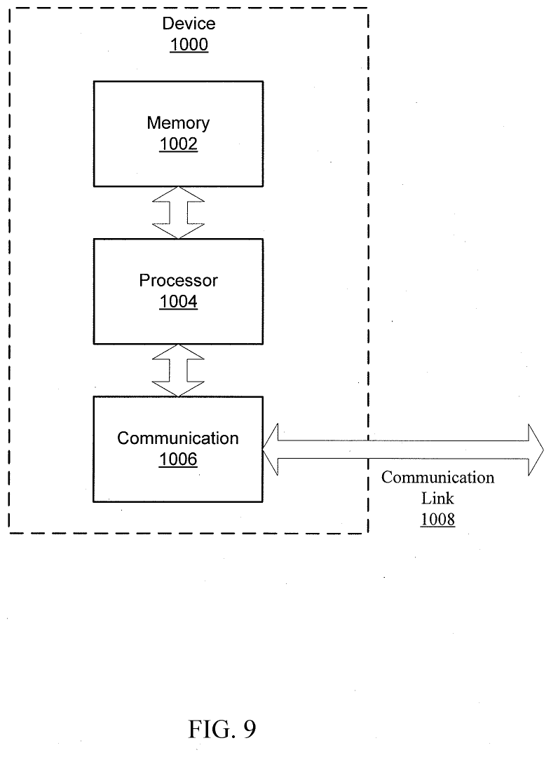

### SUMMARY OF THE INVENTION

This section is intended to provide a summary of certain exemplary embodiments and is not intended to limit the scope of the embodiments that are disclosed in this application.

Systems and methods for determining the state of a television in an HDMI system. The method includes receiving audio/video content from an HDMI device through an HDMI cable, wherein data streams received through the HDMI cable includes HDMI CEC messages. The received HDMI CEC messages are monitored to determine if audio/video content from an HDMI device is routed to a television. The received HDMI CEC messages are also analyzed to determine if the television is powered on. The determinations in the monitoring and analyzing are used to take a predetermined action.

Disclosed embodiments further relate to a method for confirming in real-time that a connected television (CTV) is displaying content. The method includes receiving streamed content at a streaming media app in a media player, and initiating a session between the CTV, the streaming media app, and a programmer server by establishing a session key using a session initiation protocol. The CTV requests configuration information from the programmer server, the configuration information including a destination table and a mapping between destination field values and hostnames. The streaming media app requests issuance of a confirmation by the CTV by sending a TV on confirmation (TVOC) message specifying an event value and destination, wherein the TVOC message is contained in video watermark payload. The CTV issues a confirmation for each confirmation requester that is from a trusted programmer and has a valid session key. The CTV closes a current session in the event of one of: 1) no valid messages received for a predetermine period of time, 2) a new session initiation is completed, or 3) a valid session end request TVOC message is received.

These and other advantages and features of disclosed embodiments, together with the organization and manner of operation thereof, will become apparent from the following detailed description when taken in conjunction with the accompanying drawings.

### DETAILED DESCRIPTION OF CERTAIN EMBODIMENTS

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

Embodiments are disclosed which enable the monitoring of the state of a television.

Television State Tracking in an HDMI Environment.

The present disclosure describes a protocol which can be implemented in a Streaming Media Player (SMP) to interpret HDMI Consumer Electronic Control (CEC) messages sent between devices in a HDMI interconnected home entertainment system to (“HDMI System”) to infer the power state and input selection of an attached TV.

A HDMI interconnected home entertainment system (“HDMI System”) typically includes a Streaming Media Player (SMP) either connected directly to a TV, or connected to an intermediate Audio Video Receiver (AVR) or Soundbar which is connected to the TV, where the connections use HDMI interfaces.

The SMP can stream media to the TV. The SMP currently has no reliable way to determine if the TV is on and has the SMP selected for display. Without this knowledge, a SMP can continue to stream media after the TV has been turned off or has selected another input to display. This can result in disadvantages for the user including excessive network usage and power consumption. It can also be a disadvantage for advertisers who are sponsoring the streams because their advertisements are not viewable.

In this disclosure the name fTVRenderingSMP denotes a Boolean variable that represents whether the TV is on and has the SMP selected for display.

### HDMI-CEC

HDMI Consumer Electronic Control (CEC) is described in High-Definition Multimedia Interface Specification Version 1.4a, which is available at https://www.hdmi.org/requestform/clickrequestasync?docId=22 and is incorporated herein by reference.

HDMI includes four different communication channels:
1. TMDS is a one-way data channel which carries audio, video and other data from the SMP to the TV.
2. DDC is used for the SMP to read the TV's EDID information to properly configure streaming format. There is no provision for EDID to provide dynamic information about fTVRenderingSMP
3. HEC is an optional high-speed bidirectional data channel, but there is no high-level protocol defined to communicate fTVRenderingSMP.
4. CEC is an optional data channel based on a bus system which provides high level control functions between devices for system setup and remote control.

Of these four, CEC is the only channel which is bi-directional and includes standardized messages which can be interpreted to infer fTVRenderingSMP.

HDMI also has a ‘Hot Plug’ detection feature (“HPD”) that uses a pin in the HDMI connector to inform a HDMI source that a HDMI sink is connected and has EDID available to read through the DDC. HPD only indicates that EDID is available and does not necessarily mean that the TV is powered on or has the content of source device selected for display.

HDMI Systems include of one or more source devices, a TV, and 0 or more HDMI switches. The physical layer provides automatic Physical Address allocation. There is a separate Logical Address space used by CEC for devices which have implemented CEC and where CEC is enabled on that device. In the disclosure below CEC messages are denoted by using brackets, with message parameters delimited by a colon, e.g. <Active Source: Physical Address>

Requirements for CEC conformance have evolved through a succession of specification revisions, and compliance with the specification is optional, as is compliance with individual features in the spec. This has led to different valid interpretations and some interoperability problems in the field.

### TV Source Selection

The TV must have the SMP selected as its source and be displaying the SMP content for fTVRenderingSMP to be true.

TV Source switching results in one or more of CEC Routing Control messages to be emitted, depending on the HDMI System connection graph, the level of CEC compliance of the devices, the presence or absence of an AVR or Soundbar, and the source of the switching control (e.g. TV Remote Control of TV menu, AVR Remote control of AVR selection, device self-selection using the ‘One Touch Play’ CEC feature). These messages include <Active Source>, <Routing Change> and <Set Stream Path>.

### Active Source

The CEC specification describes a property of a CEC enabled HDMI interconnected system called ‘active source’, which generally refers to the source currently being displayed on the TV.

The <Active Source> CEC message is used by a device to assert that it is the active source, and the <Request Active Source> message can be broadcast by any device to query what device is the current active source.

For example, the table below shows a log of CEC messages relevant to this discussion which were captured with a kwikwai k110 pro test tool, which is available at https://kwikwai.com/products-2/. The kwikwai can be used to probe the HDMI System by injecting CEC messages to query other CEC devices about their power and active source state. Such probes could be done as part of an algorithm implemented in a SMP to determine fTVRenderingSMP. In one embodiment, the HDMI System under test uses an AppleTV A1842 as the SMP connected to a Sony KD-55X80J TV which also has a Roku 4660X Media Player connected to another TV HDMI input. Starting with the SMP as active source with its content displayed on the TV, the user selects the Roku device by using the Roku's ‘One Touch Play’ CEC feature (v1.4 spec CEC 13.1). The Roku sends <Image View On> and <Active Source> messages per the spec, and a later probe using <Request Active Source> correctly identifies the Roku device.

| Time | Src | Dest | Command | Parameters |
|---|---|---|---|---|
| 17.45:26.7 | Roku | Broadcast | Active Source (82) | Physical Address: 2.0.0.0 |
| 17.45:26.6 | Probe | Broadcast | Request Active Source (85) | |
| 17.45:11.9 | Roku | Broadcast | Active Source (82) | Physical Address: 2.0.0.0 |
| 17.45:11.8 | Roku | TV | Image View On (04) | |
| 17.45:10.4 | Roku | Broadcast | Active Source (82) | Physical Address: 2.0.0.0 |
| 17.45:07.9 | Roku | Broadcast | Active Source (82) | Physical Address: 2.0.0.0 |
| 17.45:07.7 | Roku | TV | Image View On (04) | |

User Action: Select Roku using ‘One Touch Play’ CEC Feature

| | | | | |
|---|---|---|---|---|
| 17.45:02.8 | SMP | Broadcast | Active Source (82) | Physical Address: 1.0.0.0 |
| 17.45:02.7 | Probe | Broadcast | Request Active Source (85) | |

Starting Condition: SMP Selected

### Routing Change

<Routing Change> messages are sent by CEC Switches when the switch is locally operated. Such a switch might be in an AVR where the source is selected on its front panel or by its remote control. Another example is the CEC Switch in a TV that selects amongst the TV's HDMI inputs in response to a user's remote-control commands.

For example, the table below shows a log of CEC messages for a HDMI System which includes an AppleTV A1842 acting as the SMP connected to a LG UK6090PUA TV. Starting with the SMP as active source with its content displayed on the TV, the user selects the TV's OTA tuner using the TV remote control. Next, the user switches back to the SMP, at which point the TV issues a <Routing Change> message and the SMP content is displayed once again on the TV. However, notice that in this case there is no <Active Source> message and no response to the <Request Active Source> probe after the switch back to the SMP.

| Time | Src | Dest | Command | Parameters |
|---|---|---|---|---|
| 10.52:43.1 | Probe | Broadcast | Request Active Source (85) | |
| 10.51:46.9 | Probe | Broadcast | Request Active Source (85) | |
| 10.51:31.4 | TV | Broadcast | Routing Change (80) | Original Address: 0.0.0.0 / |
| | | | | New Address: 1.0.0.0 |

User Action: Select SMP

| | | | | |
|---|---|---|---|---|
| 10.51:11.8 | TV | Broadcast | Active Source (82) | Physical Address: 0.0.0.0 |
| 10.51:11.7 | Probe | Broadcast | Request Active Source (85) | |
| 10.50:43.0 | TV | Broadcast | Active Source (82) | Physical Address: 0.0.0.0 |
| 10.50:43.0 | TV | SMP | User Control Released (45) | |
| 10.50:42.0 | TV | SMP | User Control Pressed (44) | UI Command: Stop |

User Action: OTA Tuner Selected Selected

| | | | | |
|---|---|---|---|---|
| 10.50:21.0 | SMP | Broadcast | Active Source (82) | Physical Address: 1.0.0.0 |
| 10.50:21.0 | Probe | Broadcast | Request Active Source (85) | |

Starting Condition: SMP Selected

### Set Stream Path

<Set Stream Path> is used by the TV to establish a streaming path between the TV and a new active source, by requesting that CEC switches between the TV and the source switch their inputs to the new source. A selected device compliant with early versions of the specification might or might not send a <Active Source> in response to <Set Stream Path>.

For example, the table below shows a log of CEC messages for a HDMI System which includes an AppleTV A1842 as the SMP connected to a Sony KD-55X80J TV, which also has a Roku 4660X Media Player connected to another TV HDMI input. Starting with the SMP as active source with its content displayed on the TV, the user uses the TV remote control to select the Roku HDMI input on the TV. The TV sends the <Set Stream Path> message and the Roku responds with <Active Source> messages, and a later probe using <Request Active Source> correctly identifies the Roku device. Note that in this case there is no <Routing Change> message sent by the TV CEC Switch as there was when the Roku was selected using its ‘One Touch’ feature in this same HDMI System in a previous example: However, some CEC Switches and TVs conforming to Version 1.3a or earlier might send a <Routing Change> message in response to a <Set Stream Path> or <Active Source> message.

| Time | Src | Dest | Command | Parameters |
|---|---|---|---|---|
| 17.47:50.4 | Roku | Broadcast | Active Source (82) | Physical Address: 2.0.0.0 |
| 17.47:50.3 | Probe | Broadcast | Request Active Source (85) | |
| 17.47:28.9 | Roku | Broadcast | Active Source (82) | Physical Address: 2.0.0.0 |
| 17.47:28.8 | TV | Broadcast | Set Stream Path (86) | Physical Address: 2.0.0.0 |

User Action: Select Roku

| | | | | |
|---|---|---|---|---|
| 17.47:20.3 | SMP | Broadcast | Active Source (82) | Physical Address: 1.0.0.0 |
| 17.47:20.2 | Probe | Broadcast | Request Active Source (85) | |

Starting Condition: SMP Selected

### Routing Message Ambiguities and Errors

There are many problems when trying to use <Active Source> to infer fTVRenderingSMP.

The use of <Active Source> by devices before v1.3a was not mandatory. v1.4 further clarified the behavior of devices in managing their Active Source state, including that when a device becomes an Active Source it must send an Active Source message, and that a device loses its Active Source status when another device asserts Active Source.

These problems manifest in different ways. In one example above, no device responded to <Request Active Source> messages even though a streaming path was established and a content from a CEC-enabled source device was being displayed on the TV. Other times, as documented below, Active Source will not accurately identify the Physical Address of the device whose content is currently being displayed. Another example is for TVs which can display more than one source at a time (e.g. the LG ‘Multi-View’ feature) which does not fit the HDMI-CEC model of a single active source. And a device can still have active source status even though the TV is turned off.

### Non-CEC Devices

An example where Active Source does not accurately identify the Physical Address of the currently displayed device is when a non-CEC device is selected as the TV source. A non-CEC device is one that does not implement CEC or implements it but has it disabled.

For example, as shown in the table below, when an LG UK6090PUA selects a non-CEC compliant device connected to one of its HDMI inputs, the TV asserts itself as the current active source, acting as a proxy for the non-compliant device.

| Time | Src | Dest | Command | Parameters |
|---|---|---|---|---|
| 11.27:42.7 | TV | Broadcast | Active Source (82) | Physical Address: 0.0.0.0 |
| 11.27:42.6 | SMP | Broadcast | Request Active Source (85) | |
| 11.27:16.6 | TV | Broadcast | Routing Change (80) | Original Address: 1.0.0.0 / |
| | | | | New Address: 3.0.0.0 |
| 11.27:16.4 | TV | Broadcast | Active Source (82) | Physical Address: 0.0.0.0 |

User Action: Select non-CEC Device at Physical Address 3.0.0.0

| | | | | |
|---|---|---|---|---|
| 11.26:56.9 | SMP | Broadcast | Active Source (82) | Physical Address: 1.0.0.0 |
| 11.26:56.8 | SMP | Broadcast | Request Active Source (85) | |

Routing Change with No <Active Source> Assertion

An example where Active Source does not accurately identify the Physical Address of the currently displayed source is shown in the following table of CEC messages recorded from a system comprising a Samsung PN50C7000 TV and an AppleTV A1842 as the SMP.

The starting condition of the test has the SMP displayed on the TV as active source; then the user selects the TV's OTA tuner using the TV remote control. Next, the user switches back to the SMP. After the switch back to the SMP, the SMP is displayed on the TV, but the TV is still responding as the Active Source when probed after the <Routing Change>.

| Time | Src | Dest | Command | Parameters |
|---|---|---|---|---|
| 12.48:38.5 | TV | Broadcast | Active Source (82) | Physical Address: 0.0.0.0 |
| 12.48:38.1 | Probe | Broadcast | Request Active Source (85) | |
| 12.48:16.7 | TV | Broadcast | Routing Change (80) | Original Address: 0.0.0.0 / |
| | | | | New Address: 1.0.0.0 |

User Action: Select SMP

| | | | | |
|---|---|---|---|---|
| 12.47:48.6 | TV | Broadcast | Active Source (82) | Physical Address: 0.0.0.0 |
| 12.47:48.1 | Probe | Broadcast | Request Active Source (85) | |
| 12.46:33.0 | TV | Broadcast | Routing Change (80) | Original Address: 1.0.0.0 / |
| | | | | New Address: 0.0.0.0 |
| 12.46:32.8 | TV | Broadcast | Active Source (82) | Physical Address: 0.0.0.0 |
| 12.46:26.5 | SMP | TV | Menu Status (8E) | Menu State: Activated |
| 12.46:26.4 | TV | SMP | Menu Request (8D) | Menu Request Type: Deactivate |
| 12.46:03.1 | SMP | TV | Menu Status (8E) | Menu State: Activated |
| 12.46:03.0 | TV | SMP | Menu Request (8D) | Menu Request Type: Query |

User Action: Select OTA Tuner

| | | | | |
|---|---|---|---|---|
| 12.46:02.6 | SMP | Broadcast | Active Source (82) | Physical Address: 1.0.0.0 |
| 12.46:02.5 | Probe | Broadcast | Request Active Source (85) | |

Initial Condition: SMP is selected

Routing Change Followed by <Set Stream Path> or <Active Source>

Based on the example above, it is tempting to prioritize the address in the <Routing Change: New Physical Address> message over the address in a <Active Source: Physical Address> message. However, the example below illustrates a case where the opposite is true: The <Active Source: Physical Address> message has the correct address but the <Routing Change: New Address> does not. This example is a system including an AppleTV A1842 as the SMP connected to an Onkyo TX-SR508 AVR which is connected to a Samsung PN50C7000 TV. The control sequence starts with the SMP being displayed on the TV. The user then switches to the TVs OTA tuner and then switches back to the SMP. When switching to the SMP, the first step the TV takes is to issue a <Routing Change> message which establishes that the TV will display the output of the AVR. The TV then broadcasts a <Set Stream Path> message with the SMPs physical address (2.1.0.0) to which the SMP responds with a <Image View On> and <Active Source> to complete the path and start streaming to the TV. In this case, shown in the table below, the <Routing Change: New Physical Address> (the AVR at 2.0.0.0) is not the new Active Source physical address (the SMP at 2.1.0.0).

| Time | Src | Dest | Command | Parameters |
|---|---|---|---|---|
| 09.50:03.8 | SMP | Broadcast | Active Source (82) | Physical Address: 2.1.0.0 |
| 09.50:03.7 | Probe | Broadcast | Request Active Source (85) | |
| 09.49:55.5 | SMP | Broadcast | Active Source (82) | Physical Address: 2.1.0.0 |
| 09.49:55.3 | SMP | TV | Image View On (04) | |
| 09.49:54.7 | TV | Broadcast | Set Stream Path (86) | Physical Address: 2.1.0.0 |

User Action: Select SMP

| | | | | |
|---|---|---|---|---|
| 09.48:46.7 | TV | Broadcast | Active Source (82) | Physical Address: 0.0.0.0 |
| 09.48:46.3 | Probe | Broadcast | Request Active Source (85) | |
| 09.48:38.8 | TV | Broadcast | Routing Change (80) | Original Address: 2.0.0.0 / |
| | | | | New Address: 0.0.0.0 |
| 09.48:38.6 | TV | Broadcast | Active Source (82) | Physical Address: 0.0.0.0 |

User Action: Select OTA Tuner

| | | | | |
|---|---|---|---|---|
| 09.46:20.2 | SMP | Broadcast | Active Source (82) | Physical Address: 2.1.0.0 |
| 09.46:20.1 | Probe | Broadcast | Request Active Source (85) | |

Initial Condition: SMP is selected

### Resolving Ambiguities

To overcome this problem of a conflict between the <Routing Change: New Physical Address> and probed <Active Source: Physical Address>, different techniques can be used:

### Ignore Irrelevant Data

One aspect of a solution recognizes that for the purpose of estimating fTVRenderingSMP, the SMP can ignore address ambiguities if neither of the addresses is the SMP's address. In other words, fTVRenderingSMP will be FALSE if neither of the addresses is the SMP address.

Track ‘Probed Active Source’ vs ‘Asserted Active Source’

Another aspect of a solution is to distinguish between:
1. an <Active Source> message that is a response to a probing <Request Active Source> message (a “Probed Active Source”), and
2. an <Active Source> message that is sent by a device asserting itself as active source such as in response to a <Set Stream> message or as part of a ‘One Touch Play’ feature (an “Asserted Active Source”).

The SMP can maintain a state variable, latestAssertedActiveSourcePhyAddr, which tracks the Physical Address of Asserted Active Sources, and which is updated by a <Active Source> message asserted by a new source. latestAssertedActiveSourcePhyAddr can invalidated by any <Set Stream Path> or <Routing Change> or <Inactive Source> message, and also by initialization functions in the SMP, such as power on initialization or when establishing a new HDMI physical address or CEC logical address.

The following example pseudo code shows the steps to update latestAssertedActiveSourcePhyAddr when a new CEC message is received:

```
  Update_latestAssertedActiveSourcePhyAddr (newCECMessage)
if newCECMessage == <Active Source: physicalAddress>
    latestAssertedActiveSourcePhyAddr = physicalAddress
else if newCECMessage == <Inactive Source>
    latestAssertedActiveSourcePhyAddr = invalid
else if newCECMessage == <Routing Change>
    latestAssertedActiveSourcePhyAddr = invalid
else if newCECMessage == <Set Stream Path>
    latestAssertedActiveSourcePhyAddr = invalid
```

An Asserted Active Source should be prioritized and treated as an authoritative source of the active source state of the HDMI System, while a Probed Active Source should have lower priority in case of address conflicts.

For example, if the <Routing Change> New Physical Address is the SMP's address yet the TV is still responding to a <Request Active Source> probe with <Active Source> as in the ‘Routing Change with no <Active Source> Assertion’ example, then the SMP can assume that the <Routing Change> address is correct and set fTVRenderingSMP TRUE; additionally, it might also reassert <Active Source> to broadcast its assumption and intention.

Deprioritize <Routing Change> addresses of Intermediate CEC Switches

Another aspect of a solution is to distinguish between
1. a <Routing Change> message from a final switch like the TV switch in the system without the AVR in the first example, and
2. a <Routing Change> message from an intermediate switch like the TV switch in the AVR example where the AVR presents an upstream switch.

The SMP can keep a state variable latestRoutingChangedNewAddr that represents New Physical Address in the last valid <Routing Change> and which should be updated for each <Routing Change> message.

When a <Routing Change> New Physical Address is that of an intermediate switch, there will be subsequent Routing Control messages (e.g. <Set Stream Path> or <Routing Change> or <Active Source>) to establish the streaming path, like the <Set Stream Path> in the “Routing Change Followed by <Set Stream Path> or <Active Source>” example. These subsequent Routing Control messages should invalidate latestRoutingChangedNewAddr which can also be invalidated by any <Set Stream Path> or <Inactive Source> message, and also invalidated by initialization functions in the SMP, such as power on initialization or when establishing a new HDMI physical address or CEC logical address.

The following is example pseudo code shows the steps to update latestRoutingChangedNewAddr when a new CEC message is received:

```
  Update_ latestRoutingChangedNewAddr (newCECMessage)
if newCECMessage == < Routing Change: newPhysicalAddress>
    latestRoutingChangedNewAddr = newPhysicalAddress
else if newCECMessage == <Active Source>
    latestRoutingChangedNewAddr = invalid
else if newCECMessage == <Set Stream Path>
    latestRoutingChangedNewAddr = invalid
```

Cover cases where <Set Stream Path> is not followed by <Active Source>

<Set Stream Path> message can be used to establish a streaming path from a device to the TV. The device is supposed to send an <Active Source> message upon receipt of the <Set Stream Path> message and commencement of streaming, but this action was not mandatory in early versions of the specification.

The SMP can keep a state variable latestSetStreamPathPhyAddr that represents the last valid <Set Stream Path> Physical Address and should be updated for each <Set Stream Path> message. It should be invalidated by any subsequent Routing Control messages (e.g. <Routing Change> or <Active Source>) and also by initialization functions in the SMP, such as power on initialization or when establishing a new HDMI physical address or CEC logical address.

The following example pseudo code shows the steps to update latestSetStreamPathPhyAddr when a new CEC message is received:

```
  Update_ latestSetStreamPathPhyAddr (newCECMessage)
if newCECMessage == < Set Stream Path: newPhysicalAddress
    latestSetStreamPathPhyAddr = newPhysicalAddress
else if newCECMessage == <Active Source>
    latestSetStreamPathPhyAddr = invalid
else if newCECMessage == < Routing Change >
    latestSetStreamPathPhyAddr = invalid
```

### TV Power State

The TV must have power state=‘On’ for fTVRenderingSMP to be true. The SMP can maintain a state variable latestTVPowerStatus to be used in the calculation of fTVRenderingSMP Several different techniques can be used to determine latestTVPowerStatus.

### <Give Device Power Status>

CEC provides a <Give Device Power Status> message to probe the power state of a device, which responds with a <Report Power Status> message. The SMP can use these to determine if the TV is in power state ‘On’ or ‘Standby’. In the absence of a response, the SMP can infer that the TV is ‘Off’. Only if the TV responds with the CEC <Report Power Status: On> message can the SMP assert fTVRenderingSMP.

The following example pseudo code shows the steps to determine latestTVPowerStatus using the <Get Device Power Status> follows:

```
PollForLatestTVPowerStatus( )
send <Give Device Power Status> message, await response
if no response
  latestTVPowerStatus = ‘ off’
else if response == ‘ standby’
  latestTVPowerStatus = ‘ standby’
else if response == ‘ on’
  latestTVPowerStatus = ‘ on’
```

When sending a CEC message, the CEC Specification describes Reliable Communication Mechanisms in CEC 7 which are assumed to be used here. These include low level mechanisms for frame retransmission, flow control and frame validation which are not explicitly listed here.

<Give Power Status> Not Implemented: Eavesdropping on <Polling Message>

<Give Device Power Status> was optional to implement in v1.3 and before. Such TVs would respond with a <Feature Abort: “unrecognized opcode”> message which means that the TV does not support the message, in which case the SMP could try an alternate method as described below.

Many TVs regularly poll connected devices using the CEC <Polling Message>. If the SMP detects that these polling messages are regularly emitted when the TV is on, then it can recognize when these messages stop to infer that the TV has been put in standby, turned off or disconnected.

For example, the following table of CEC messages was recorded from a system comprising a LG OLED65E6P TV and an AppleTV A1842 as the SMP. Here, <Polling Message>s are repeated approximately every 15 seconds. It is also observed that the <Polling Message>s are not sent when the TV is not on. Different TVs use different polling intervals, and while there is not a requirement for TVs to poll, the use of <Polling Message> by the TV has been widely observed with polling intervals always less than one minute.

| | Logical Addr | | | |
|---|---|---|---|---|
| Time | Src | Dest | Command | Parameters |
| 09.57:26.4 | 0 | 3 | Report Power Status (90) | Power Status: On |
| 09.57:26.3 | 3 | 0 | Give Device Power Status (8F) | |
| 09.57:16.5 | 0 | 2 | Polling Message | |
| 09.57:16.4 | 0 | 1 | Polling Message | |
| 09.57:16.3 | 0 | 11 | Polling Message | |
| 09.57:16.2 | 0 | 10 | Polling Message | |
| 09.57:16.0 | 0 | 9 | Polling Message | |
| 09.57:15.9 | 0 | 5 | Polling Message | |
| 09.57:15.7 | 0 | 8 | Polling Message | |
| 09.57:15.6 | 0 | 4 | Polling Message | |
| 09.57:15.5 | 0 | B | Device Vendor ID (87) | Vendor ID: 57489 |
| 09.57:03.4 | 8 | B | Active Source (82) | Physical Address: 4.0.0.0 |
| 09.57:03.2 | 3 | B | Request Active Source (85) | |
| 09.57:01.4 | 0 | 2 | Polling Message | |
| 09.57:01.4 | 0 | 2 | Polling Message | |
| 09.57:01.3 | 0 | 1 | Polling Message | |
| 09.57:01.2 | 0 | 11 | Polling Message | |
| 09.57:01.0 | 0 | 10 | Polling Message | |
| 09.57:00.9 | 0 | 9 | Polling Message | |
| 09.57:00.8 | 0 | 5 | Polling Message | |
| 09.57:00.6 | 0 | 8 | Polling Message | |
| 09.57:00.5 | 0 | 4 | Polling Message | |
| 09.57:00.4 | 0 | B | Device Vendor ID (87) | Vendor ID: 57489 |
| 09.56:53.8 | 8 | 0 | Menu Status (8E) | Menu State: Activated |
| 09.56:53.7 | 8 | B | Active Source (82) | Physical Address: 4.0.0.0 |
| 09.56:53.5 | 8 | 0 | Image View On (04) | |
| 09.56:53.5 | 8 | B | Report Power Status (90) | Power Status: On |
| 09.56:46.4 | 0 | 2 | Polling Message | |
| 09.56:46.3 | 0 | 1 | Polling Message | |
| 09.56:46.1 | 0 | 11 | Polling Message | |
| 09.56:46.0 | 0 | 10 | Polling Message | |
| 09.56:45.9 | 0 | 9 | Polling Message | |
| 09.56:45.8 | 0 | 5 | Polling Message | |
| 09.56:45.6 | 0 | 8 | Polling Message | |
| 09.56:45.5 | 0 | 4 | Polling Message | |
| 09.56:45.4 | 0 | B | Device Vendor ID (87) | Vendor ID: 57489 |
| 09.56:41.6 | 4 | B | Active Source (82) | Physical Address: 1.0.0.0 |
| 09.56:41.5 | 3 | B | Request Active Source (85) | |
| 09.56:34.4 | 0 | 3 | Report Power Status (90) | Power Status: On |
| 09.56:34.3 | 3 | 0 | Give Device Power Status (8F) | |

Algorithm for Determining latestTVPowerStatus

An example of a method for determining latestTVPowerStatus that includes some of the solutions disclosed above is described below:

### Initialization

The following example pseudocode shows that the initialization of the system can determine if eavesdropping is necessary to determine latestTVPowerStatus. Initialize TVPowerStatus( )

```
fUseEavesdropping = false
send <Give Device Power Status> message, await response
if no response
  latestTVPowerStatus = ‘ off’
else if response == ‘ standby’
  latestTVPowerStatus = ‘ standby’
else if response == ‘ on’
  latestTVPowerStatus = ‘ on’
else if response is <Feature Abort: “Unrecognized opcode”>
  fUseEavesdropping = true
  Initialize_Eavesdropping( )
```

This initialization can happen when the user first starts streaming content. At this point in time, the user will have established that the SMP user interface and content is being displayed on the TV, and the SMP can start a recurring background process to look for <Polling Message>. As soon as one is found latestTVPowerStatus can be set to ‘on’ and a watchdog timer can be set. If the watchdog timer expires, latestTVPowerStatus can be set to ‘off’. A watchdog time is an asynchronous process which periodically decrements a counter and calls a WatchdogTimerExpire( ) function when the counter reaches 0. Example pseudo code for this follows:

```
Initialize_Eavesdropping( )
  For each CEC message received
    if message == <polling message) and messageSender == TV
      latestTVPowerStatus = ‘ on’
      WatchdogTimerReset( )
WatchdogTimerReset ( )
  timer = 60,000 milliseconds
WatchdogTimerExpire ( )
  latestTVPowerStatus = ‘ off’
```

In this example the watchdog timer is decremented every millisecond and is reinitialized to 60 seconds when a <Polling Message> is received, but other timer resolution and initialization values could be used. In particular, the actual interval between groups of <polling Message>s could be estimated by collecting the value of the timer prior to reinitialization every time it is reset. The smallest value of this value when tracked over several minutes represents the difference between the initialization value and the actual interval, and this value can be used to decrease the latency of detecting a transition to latestTVPowerStatus=‘off’.

Note that messages other than <Polling Message> could be used in the eavesdropping algorithm.

Getting latestTVPowerStatus

An example algorithm to get the current value of latestTVPowerStatus after InitializeTVPowerStatus( ) using either the <Give Device Power Status> or the eavesdropping method follows:

```
GetLatestTVPowerStatus( )
  if fUseEavesdropping == false
    PollForLatestTVPowerStatus( )
  return latestTVPowerStatus
```

### HPD

In some limited use cases, HPD can be used as a proxy for latestTVPowerStatus. Some TVs will assert this signal only when powered on, and this could be used when the SMP is directly connected to the TV. In this case, upon notification that HPD has been asserted, the SMP can set latestTVPowerStatus=‘On’, and upon notification that HDP has been de-asserted, the SMP can set latestTVPowerStatus=‘Off’.

Method for Estimating fTVRenderingSMP

An example method that includes some of the solutions disclosed above is

described below.

### Assumptions

It is assumed that the SMP is connected to the HDMI system, has CEC enabled, has a valid logical address, and is able to send and monitor CEC messages, which it can determine by querying its HDMI interface.

It is also assumed that the TV has implemented CEC and that it is enabled. This assumption can be tested by the SMP by observing that there is a device with logical address 0 in the system. For example, it could passively monitor messages and look for a source or destination logical address equal to 0; or it could send a <Give Physical Address> or <Give Device Power Status> message to logical address 0, and a response indicates that the TV implements CEC.

It is not assumed that other devices in the HDMI system have implemented CEC or that it is enabled on those devices.

### State Variables

The latestSetStreamPathPhyAddr, latestRoutingChangedNewAddr, latestAssertedActiveSourcePhyAddr, and latestTVPowerStatus variables are managed as described earlier.

SMPPhysicalAddress is the HDMI physical address of the SMP.

fTVRenderingSMP is the output of the algorithm. It is a Boolean variable that represents whether the TV is on and has the SMP selected for display.

Example Method for determining fTVRenderingSMP

An example of a method to determine fTVRenderingSMP:

```
Get_fTVRenderingSMP( )
  fTVRenderingSMP = ‘Indeterminate’
  if latestTVPowerStatus != ‘on’:
    fTVRenderingSMP = ′False′
  else if latestAssertedActiveSourcePhyAddr == SMPPhysicalAddress \
    or latestSetStreamPathPhyAddr == SMPPhysicalAddress \
    or latestRoutingChangedNewAddr == SMPPhysicalAddress :
      fTVRenderingSMP = ′True′
  else if latestAssertedActiveSourcePhyAddr != ′invalid ‘\
    or latestSetStreamPathPhyAddr != invalid \
    or latestRoutingChangedNewAddr != invalid :
      fTVRenderingSMP = ′False′
  return(fTVRenderingSMP )
```

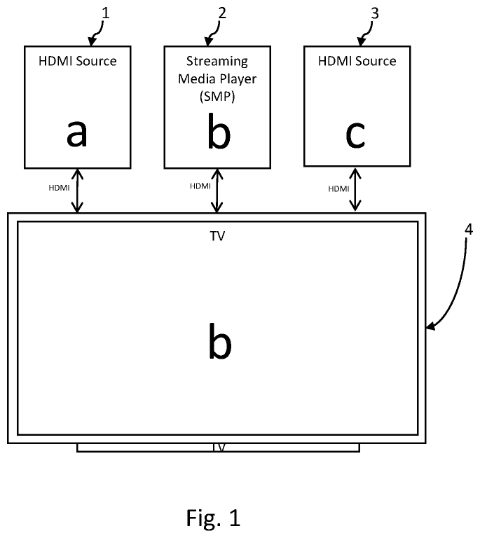

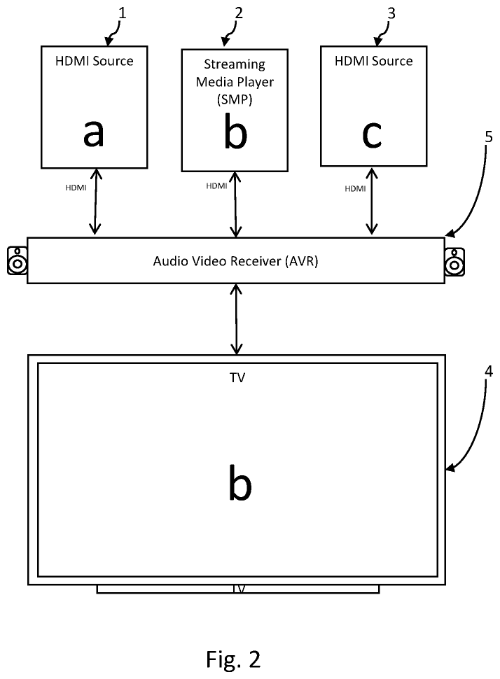

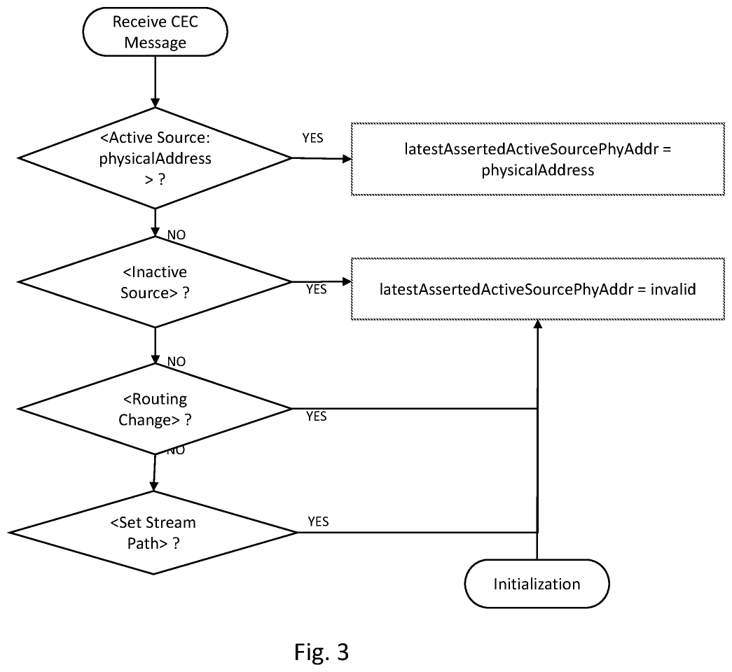

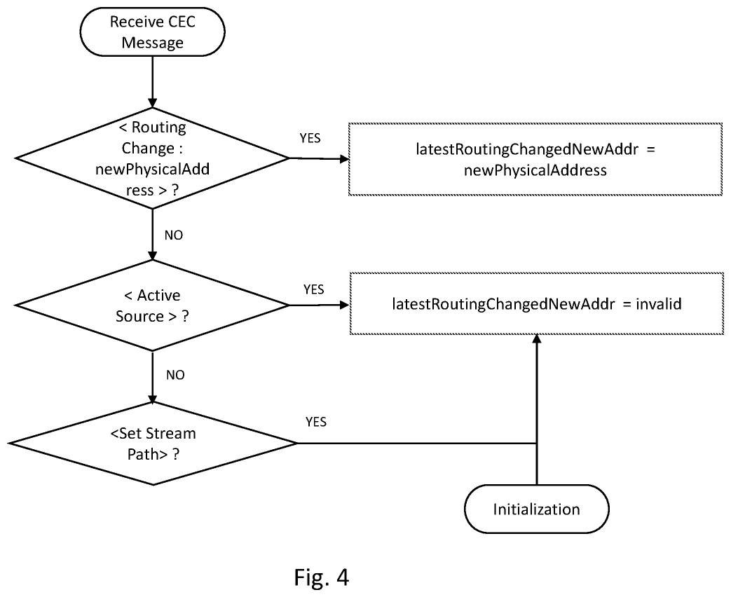

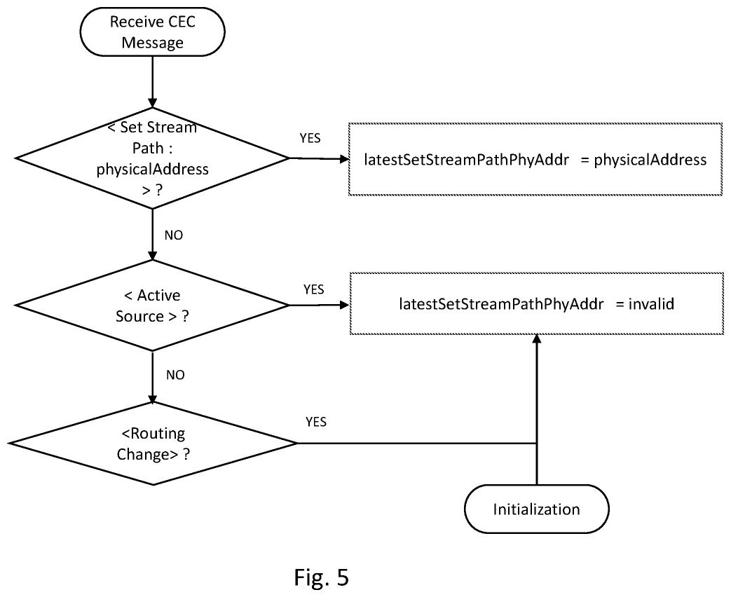

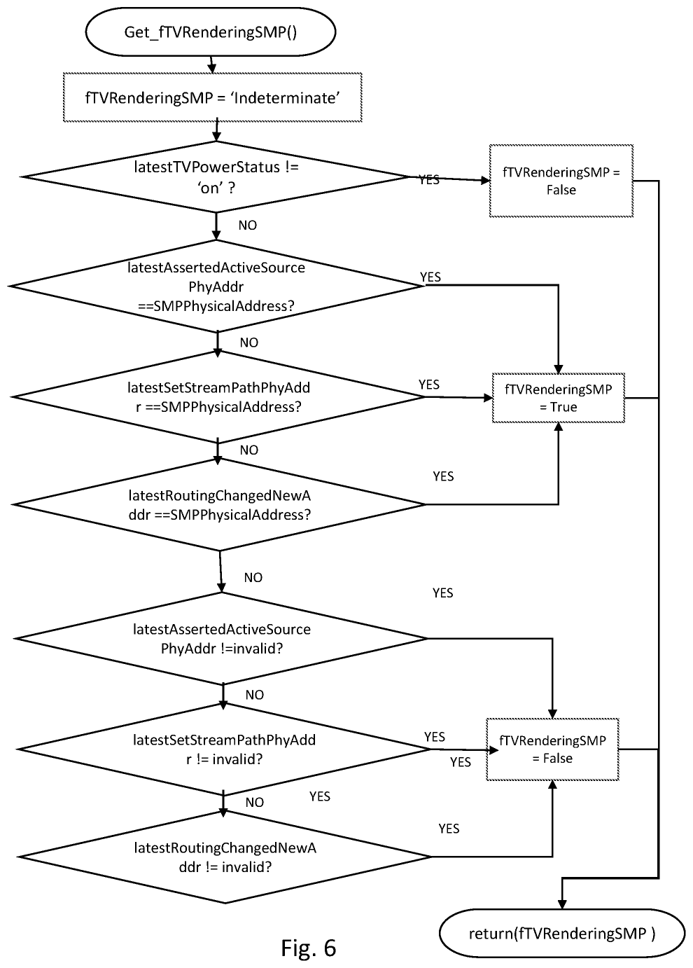

FIG. 1 illustrates a block diagram of an HDMI system with a SMP, two other HDMI sources, and a TV in according with an exemplary embodiment. FIG. 2 illustrates a block diagram of an HDMI system with a SMP, two other HDMI sources, an AVR and a TV in according with an exemplary embodiment. FIG. 3 illustrates a set of operations that can be used to determine lastestAssrtdActiveSourcePhyAddr according with an exemplary embodiment. FIG. 4 illustrates a set of operations that can be used to determine lastestRoutingChangdNewAddr according with an exemplary embodiment. FIG. 5 illustrates a set of operations that can be used to determine lastestSeetStreamPathPhyAddr according with an exemplary embodiment. FIG. 6 illustrates a set of operations that can be used to determine Get_fTVRenderingSMP( ) according with an exemplary embodiment.

Another embodiment enables a streaming media app running on a streaming media player connected to a TV via HDMI to obtain real-time confirmation of when a TV starts and ends presentation of its content. This embodiment also enables advertisers in the content played by those same streaming media apps to obtain real-time confirmation from the TV, similar to those provided by the media player. This embodiment also enables OEMs to control which streaming media apps their CTVs will provide these capabilities for and enables these capabilities when advertisements are delivered directly to the streaming media app from a third-party ad server. These capabilities are also enabled for streaming media program content that was encoded without watermarks. The embodiment enables these capabilities on existing streaming media player platforms including Chromecast, Apple TV, Roku, and Fire TV without requiring any action on the part of the platforms, including OS or firmware updates. This embodiment also enables these capabilities with minimal (or no) change to existing ATSC, HbbTV and DVB watermark-related standards and their implementations and does so in a way that facilitates its standardization and promotion by other standards organizations with interest in address the stated problem who may standardize the protocols described herein that are built upon existing watermark standards. Details related to the aforementioned watermark-related standards and their implementations may be found in ATSC A/334, ATSC A/335, ATSC A/336, ETSI TS 103 464, DVB Blue Book 178-1r1, as well as US Pat. Pub. No. 2015-0261753, which is incorporated herein by reference.

### Assumptions

In the disclosure of this embodiment, the following assumptions are being made:
1. A streaming media app running on a streaming media player can embed video watermarks into the stream as a graphical overlay.
2. Streaming services are free to deploy updates to their streaming media player applications at-will.
3. Existing streaming media player platforms provide streaming media apps with graphical overlay capabilities sufficient to generate a video watermark that conforms to A/335.
4. A video watermark embedder running in a streaming media app cannot employ a PVM.
5. A video watermark embedder running in a streaming media app cannot precisely synchronize the watermark message with the media timeline (e.g. +/−200 ms timing accuracy).
6. A video watermark embedder running in a streaming media app cannot change the watermark message frequently (e.g. +/−100 ms duration control).

In the disclosure of this embodiment, the following Roles are assumed:
1. CTVs are connected televisions that support “TV On” confirmation capabilities.
2. OEMs manufacture CTVs.
3. Streaming media players are an HDMI source device that runs streaming media apps.
4. Streaming media apps are software applications that runs on a streaming media player and play program and ad content from a Programmer.
5. Publishers provides viewers with streaming media apps that enable playback of their programs and ads.
6. Viewers are end-users of streaming media apps on streaming media players connected to CTVs.
7. Advertisers place ads on streaming media apps or are agents of those who place ads; e.g. measurement service providers.

### Data Structures

“TV On” Confirmation Video Watermark Message

We may specify a “TV On Confirmation” message (or “TVOC”) that can be conveyed as a video watermark message which can be consumed and processed by either an ATSC A/344 or HbbTV interactive application (“Broadcaster Application” or “BA”) or by the CTV natively. The ATSC A/344 standard is available at https://prdatsc.wpenginepowered.com/wp-content/uploads/2023/05/A344-2023-05-Interactive-Content.pdf and is incorporated herein by reference. The details of the TVOC and the video watermark could be standardized by an industry body such as IAB Tech Labs and registered as a “code point” for the wm_message_id field in ATSC A/336 with ATSC. The ATSC A/336 standard is available at https://prdatsc.wpenginepowered.com/wp-content/uploads/2023/08/A336-2023-08-Content-Recovery-in-Redistribution-Scenarios.pdf and is incorporated herein by reference.

We may constrain the video watermark message size to enable its carriage within a single video watermark message fragment. This will minimize the complexity of the embedder implementation, minimize demands on the streaming media player system, and minimize the insertion duty cycle and consequent interference with other uses of the video watermark. The following table provides an example definition for the Video watermark message format.

| Field | No. of Bits | Format |
|---|---|---|
| run_in_sequence | 16 | uimsbf |
| wm_message_id | 8 | uimsbf |
| wm_message_block_length | 8 | uimsbf |
| wm_message_version | 4 | uimsbf |
| fragment_number | 2 | uimsbf |
| last_fragment | 2 | uimsbf |
| wm_message_bytes | | |
| tvoc_version | 8 | uimsbf |
| programmer | 60 | uimsbf |
| programmer_ext | 4 | uimsbf |
| session | 32 | uimsbf |
| destination | 16 | uimsbf |
| event | 48 | uimsbf |
| CRC_32 | 32 | uimsbf |

wm_message_id

The wm_message_id can have the value 0x60 (currently reserved; must be registered with ATSC Code Point Registry).

wm_message_block_length

The wm_message_block_length field can have the value 29.

wm_message_version

The wm_message_version field can start at 0 and be incremented for each successive modified instance of the TVOC inserted into a video stream. (Note that 10 incrementing may not occur if different embedder instances are activated on the same video stream, either in series in the distribution chain or at the same location following an embedder instance change)

fragment_number, last_fragment

The fragment_number and last_fragment fields can have the value 0.

tvoc_version

The tvoc_version field can have the value “0”, indicating that the data field conforms with this pre-release, version 0 data format. When a stable initial release of this specification is finalized, this requirement can be amended to require the value “1” be used. Any subsequent, incompatible, revision can increment the value required to be conveyed in this field.

### Programmer

The programmer field may be all or part of an ICANN hostname registered to the programmer. It is used to identify the origin of the confirmation request as well as to locate the programmer's validation server. It uses a custom encoding of up to 10 characters with 6 bits per character (60 bits total) with values representing hostname characters as specified in the table below. If fewer than 10 characters are used, the field can be null terminated and padded.

| Value (decimal) | Destination Hostname Character |
|---|---|
| 0 | End of string |
| 1-26 | “a”-“z” |
| 27-36 | “0”-“9” |
| 37 | “-” (dash) |
| 38 | “.” (period) |
| 39-63 | reserved |

programmer_ext

The programmer_ext field may identify a hostname extension string for appending to the programmer field. It uses a custom encoding with values representing strings to append as specified in the table below.

| Value | Destination Extension String |
|---|---|
| 0 | No extension string used |
| 1 | “.com” |
| 2 | “ net” |
| 3 | “ tv” |
| 4-15 | reserved |

### Session

The session field may carry an unsigned integer used to initiate and secure the confirmation session between the streaming service application and the CTV. During session initiation it carries a mailbox address selected by the programmer. During the session it carries a session key selected by the CTV. It is always a shared secret between the programmer and the CTV and must never be disclosed to any third-party.

### Destination

The destination field can convey a numeric value that uniquely identifies the intended recipient of a confirmation message, which can be a server operated by either the streaming service or a third party (e.g. advertiser or measurement company). It can carry an index into a destination table provided to the CTV by the validation server. The destination field value 0 indicates that the message is a control message whose destination is the CTV itself, in which case the event field carries a predefined meaning per this specification. The destination field value 1 indicates that the destination is the programmer hostname specified by the programmer and programmer_ext fields of the TVOC message. All other destination field values are indices into a Destination Table provided to the CTV by the programmer as part of the confirmation configuration (see “Confirmation Configuration” section below).

### Event

The event field is an unsigned integer.

When the destination field has a non-zero value, this field can contain programmer-defined data and may be subject to coordination with third-parties authorized by the programmer to receive confirmation messages from CTVs. It is expected to be used to pair confirmation messages from CTVs to streaming service application playouts (e.g. an impression or time-based session identifier).

When the destination field has the value 0, the event field may carry control data as specified in the table below.

Predefined value for event field in TVOC control messages.

| Event field | |
|---|---|
| value | Meaning |
| 0 | Session initiation request |
| 1 | Session ready notification |
| 2 | Session end request |
| 3 | Session keep-alive request |
| other | Reserved for future use |

### Confirmation Configuration

The confirmation configuration is specified by the programmer using a JSON structure with the contents shown in the following table:

Data model for Confirmation Configuration data.

| Element or Attribute | | | Data | |
|---|---|---|---|---|
| Name | | Use | Type | Format |
| ConfirmationConfiguration | | 1 | | Root element |
| | version | 1 | integer | Confirmation configuration spec |
| | | | | version |
| | DestinationTable | 0 . . . 1 | | A table identifying confirmation |

| | | destinations |
|---|---|---|
| DestinationEntry | 1 . . . N | A confirmation destination |

| Destination | 1 | integer | A value indicated in the TVOC |
|---|---|---|---|
| | | | message destination field (must be >1) |
| DestinationName | 1 | string | The destination hostname associated |

with a Destination value

The configuration is delivered to the CTV by the programmer as part of the session protocol specified below. A JSON schema is one method that can be used for representation of the Confirmation Configuration data.

### Session Protocols

### Session Initiation Protocol

### Overview

The session initiation protocol establishes a shared secret, the session key, between a Streaming Media App and a CTV. Its purpose is to ensure that an unauthorized programmer cannot collude with the operator of an approved destination of an authorized programmer to obtain confirmations of their content. Confirmations delivered to destinations with hostnames not registered to an authorized programmer based on requests outside of a session cannot be guaranteed to be associated with an authorized programmer's content.

The CTV is a connected television. Its behaviors in this protocol may be performed natively or alternatively by a CTV App running in an interactive runtime environment (e.g. ATSC A/344 or HbbTV).

A Streaming Media App is a streaming media application that includes the video watermarking SDK and is running on a HDMI source device.

A Programmer Server is a broadband server under the control of the programmer.

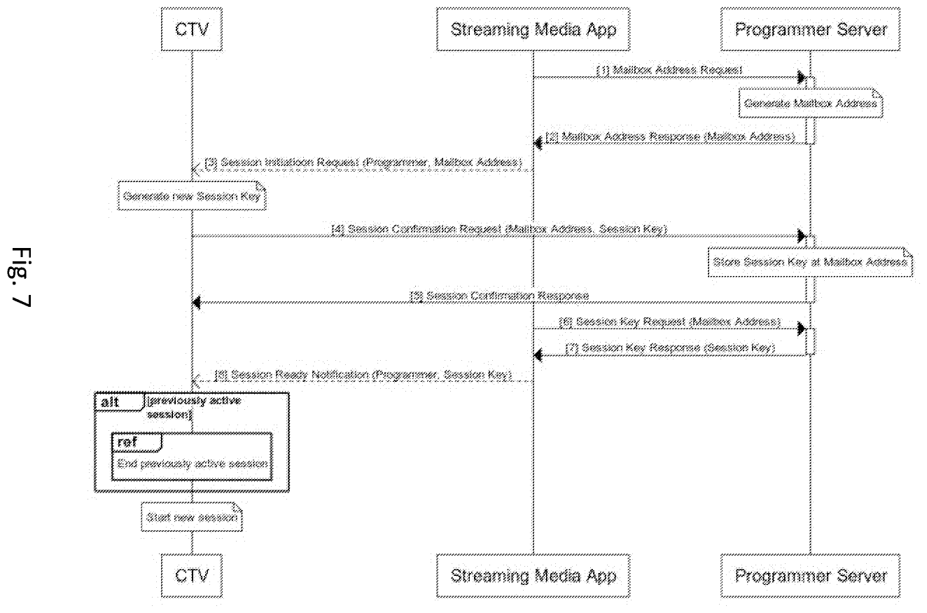

FIG. 7 illustrates a sequence diagram of a session initiation protocol according with an exemplary embodiment. Solid lines in FIG. 7 are TLS-secured broadband connections. Dashed lines are video watermark messages in the content played over HDMI from the Streaming Media App to the CTV.

In steps 1 and 2 in FIG. 7, the Streaming Media App requests and obtains a Mailbox Address from the Programmer Server. The Mailbox Address can be unique to this session initiation process instance until step 7 is completed (within the scope of this Programmer) and chosen by the Programmer Server from a range that fits into the session field of the TVOC message. The selection of a Mailbox Address is preferably performed using a secure random number generator with a suitably chosen seed to reduce the efficacy of a mailbox poisoning attack by fraudulent CTVs. The Mailbox Address is a database key that will be used by both the CTV and Streaming Media App to pass the session key from the CTV to the Streaming Media App. While transactions between the Streaming Media App and Programmer Server are internal to the programmer, they can be standardized to allow implementations of this protocol to port across programmers. This will enable its inclusion in the IAB Tech Labs Open Measurement SDK for Streaming Media Apps.

In step 3, the Streaming Media App requests that the CTV participate in the session initiation protocol by sending a Session Initiation Request watermark message to the CTV. A Session Request watermark message is a TVOC message with its registered hostname in the programmer/programmer_ext field, the Mailbox Address that it received from the Programmer Server in the session field, and pre-defined values in the destination and event fields that identify the message as a Session Initiation Request. Only one instance of the Session Initiation Protocol can be underway on a CTV at a time. Repeated transmission of this message with the same message values is permitted and successive receptions will be ignored but receipt by a CTV of a Session Initiation Request with different message values during the Session Initiation Protocol will cause the current initiation process to be abandoned and the protocol to be restarted.

Upon receipt of the Session Initiation Request, the CTV can decide (e.g. based on the hostname given in the publisher field) whether to honor the request. If it doesn't want to honor the request, it simply ignores it. If the CTV decides to permit a session to be initiated, it generates a session key. The session key can be generated in a manner as to be unguessable by a hostile programmer, preferably by a secure random number generator with a suitably unpredictable seed value.

In step 4, the CTV sends a Session Initiation Confirmation message to the Programmer Server identified in the TVOC message that includes the Mailbox Address it obtained from the TVOC message in step 3 and the session key it has generated.

In step 5, the Programmer Server provides confirmation to the CTV that the Mailbox Address provided in step 4 is currently active and valid. A negative response indicates that it is not, in which case the CTV can abandon the session initiation attempt, discarding the session key and Mailbox Address.

In step 6, the Streaming Media App polls the Programmer Server with its assigned Mailbox Address to discover whether the session key has been placed there by the CTV. This step may be initiated by the Streaming Media App at any time after it has sent the Session Request (step 3).

The response from the Programmer Server in step 7 will be negative (no session key available at that Mailbox Address) prior to the CTV completing step 4 and positive, including the session key from the Mailbox Address, subsequently. Once the Programmer Server has delivered a positive response to the Streaming Media App it can retire the Mailbox Address.

In step 8, once the Streaming Media App receives the session key, it sends a Session Ready Notification watermark message to the CTV. This is a TVOC message with its Programmer hostname in the programmer and programmer_ext fields, the session key in the session field, and pre-defined values in the destination and event fields that identify the message as a Session Ready Notification message. When the CTV receives this message, session initiation protocol is complete, the CTV will close any pre-existing session, and the Streaming Media App can proceed to deliver confirmation requests to the CTV via TVOC messages with the established session key in the session field.

### Mailbox Address Request/Response

This transaction is between two systems controlled by the same entity. This entity can use any method known in the art for retrieval of the Mailbox Address.

### Session Initiation Request

The session initiation request is a TVOC video watermark message where the programmer/programmer_ext fields contain a domain name registered to the programmer making the request, the session field carries a mailbox address selected by the Programmer Server, the destination field has the pre-defined value indicating that it is a control message, and the event fields has the pre-defined value indicating that it is a session initiation request.

### Session Initiation Confirmation Request/Response

The session initiation confirmation request can be an HTTPS GET request employing the following URL template: https://tvoc.<programmer><programmer ext>/tvoc?t=sic&m=<mailbox_address>&s=<session key>

The session initiation confirmation response can indicate if the mailbox address is active and/or if the mailbox address is inactive.

### Session Key Request/Response

This transaction is between two systems controlled by the same entity. This entity can use any method known in the art for retrieval of the Session Key.

### Session Ready Notification

The session ready notification is a TVOC video watermark message where the programmer/programmer_ext fields contain a domain name registered to the programmer making the request, the session field carries the session key generated by the CTV and obtained by the Streaming Media App from the Programmer Server, the destination field has the pre-defined value indicating that it is a control message, and the event field has the pre-defined value indicating that it is a session ready notification.

### Session Protocol

### Overview

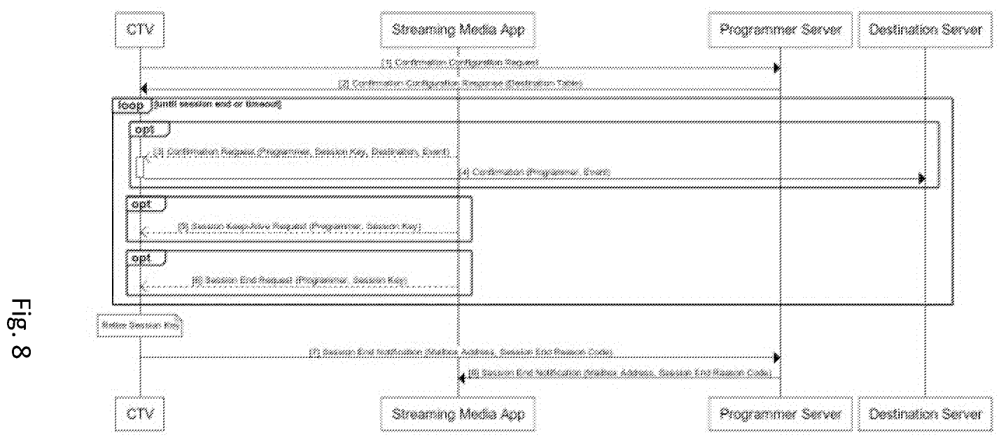

Once session initiation is completed, the session operation protocol commences. FIG. 8 illustrates a sequence diagram of a session operation protocol according with an exemplary embodiment.

In step 1 & 2 in FIG. 8, the CTV requests and obtains configuration information from the Programmer Server. This includes a Destination Table with a mapping between destination field values and hostnames. This table is stored by the CTV and used for the duration of the session. Failure to provide a valid Confirmation Configuration response will cause the session to be ended by the CTV.

For the duration of the session, the Streaming Media App must include the same programmer hostname (programmer and programmer_ext fields) and session key (session field) in all TVOC messages (including session end request messages). Messages with these values sent while the session is active are deemed “valid” session messages for purposes of the Session Protocol.

In step 3, the Streaming Media App requests issuance of a confirmation by the CTV by sending a TVOC message specifying an event value and destination. The destination identifies a hostname from the Destination Table for the session that will be the recipient of the confirmation message. The event value identifies the event being confirmed and is passed by the CTV to the destination without modification.

The CTV will issue a confirmation (step 4) for each confirmation request that is from a trusted programmer and has a valid session key, however CTVs can de-duplicate multiple identical confirmation requests and rate limit the total number of requests over a pre-defined interval of time (e.g. de-duplication and rate limiting to 5 confirmation requests issued per 5 second).

The current session can be closed by the CTV anytime no valid message has been received for one minute (“timeout”), anytime a new session initiation is completed, or upon receipt of a valid session end request TVOC message (step 6).

The Streaming Media App may issue keep-alive messages (step 5) in order to avoid session timeout during time periods where no confirmation requests are issued. The CTV can reset the timeout period when a valid keep-alive message is received.

The CTV is only required to maintain one active session at a time. A CTV can attempt to initiate a new session while another session is already active and the existing session will not be closed until the new session is active.

### Confirmation Configuration Request/Response

The confirmation configuration request can be an HTTPS GET request employing the following URL template:

https://tvoc.<programmer><programmer ext>/tvoc?t=cc

The session initiation confirmation response can be a JSON document containing Confirmation Configuration data.

### Confirmation Request

A confirmation request is a TVOC video watermark message that is valid for the session where the destination field identifies a Destination from the Destination Table in the Confirmation Configuration.

### Confirmation Message

A confirmation can be an HTTPS GET issued by the CTV TVOC function that employs the following URL template: https://tvoc.<destination name>/tvoc?t=cm&p=<programmer><programmer ext>&e=<event>

This template may be extended to include optional parameters carrying additional information known to the CTV that provides utility to the Destination.

### Session Keep-Alive Request

A session keep-alive request is a TVOC video watermark message that is valid for the session and for which the destination field has the pre-defined value indicating that it is a control message and the event field has the pre-defined value indicating that it is a session keep-alive request.

### Session End Request

A session end request is a TVOC video watermark message that is valid for the session and for which the destination field has the pre-defined value indicating that it is a control message and the event field has the pre-defined value indicating that it is a session end request.

### Session End Notification

In step 7 in FIG. 8, the session end notification issued by a CTV can be an HTTPS GET request employing the following URL template: https://tvoc.<programmer><programmer_ext>/tvoc?t=se&m=<mailbox_address>&rc=<reason_code>

The reason code can have a meaning as given in the following table.

| Reason Code Value | Meaning |
|---|---|
| 0 | Session End Request |
| 1 | Session Timeout |
| 2 | New Session Initiated |
| Other | Reserved for future use |

In step 8, a session end notification issued by a Programmer Server is sent to the streaming media app. This entity can use any method known in the art for transmission of a session end notification.

### CTV TVOC Function

### CTV TVOC Use Cases

The TV On confirmation function can be supported on a CTV using either a native “TV On” Confirmation capability built into the CTV (“CTV App”) or using a Broadcaster Application provided by the streaming service provider that is running in the A/344 or HbbTV runtime environment (a “Interactive App”). An individual CTV can support either one or both of these methods.

### CTV App

For TVs that support TVOC natively, the CTV TVOC function described is performed by the CTV App using the video watermark only. Audio watermarking is not required for this function to operate.

In this use case, TVOC permissions management is applied based on the domain identified in the programmer/programmer_ext fields of the Session Request message. This ensures it is supplemented by the security features of the Session protocol.)

For TVs that support both native and CTV App TVOC, the native CTV TVOC function will remain active except when an Interactive App is running and is subscribed to the “tv.tvoc” event stream.

### Interactive App

For TVs that support performing the CTV TVOC function using an Interactive App, the content must contain an audio watermark that points to application signaling that launches a Broadcaster App. An Interactive App is simply a Broadcaster App that subscribes to the Event Stream named “tv.tvoc” through which it will receive TVOC video watermark messages.

In this use case, permissions management is applied to application launch based on the VP1 server code in the audio watermark and application signaling in the RDT, the same as for other Broadcaster Applications.

When a CTV is running an Interactive App, the CTV can pass any TVOC video watermark messages received to the application using the A/344 Event Stream API or HbbTV Stream Events API. The Interactive App uses these messages to implement the session protocol.

CTVs that are ATSC-compliant, need to convert the TVOC video watermark message fields into an A/344 Event Stream API response. To do so, it can populate the schemeIdURI element with the string “tv.tvoc”, the data element with the base64 encoded wm_message_bytes field, the contentEncoding element (if supported) with “base64”, and the eventTime element with the media presentation time of the first video frame in which the TVOC message was decoded. Other optional A/344 Event Stream API elements can be absent.

If the CTV is HbbTV-compliant, to do this it will need to convert the wm_message_bytes fields into an HbbTV Stream Event API response. To do so, it can populate the event_name element with the string “tv.tvoc”, the data element with the contents of the wm_message_bytes field, and the text element with an empty string (“ ”).

### CTV TVOC Function

The CTV TVOC function is most easily understood as an event-driven state machine. Its behavior is defined in the two tables below. All TVOC messages with tvoc_version not equal to 0 can be ignored.

Pre-defined constants for CTV TVOC function (native or Interactive App).

| Name | Value |
|---|---|
| Session Initiation Timeout Constant | 30 seconds |
| Session Timeout Constant | 1 minute |
| Recent Confirmation Time Constant | 5 seconds |
| Recent Confirmation Limit Constant | 2 confirmations per |
| | Recent Confirmation |
| | Time Constant interval |

State machine for CTV TVOC function (native or Interactive App).

| State | Event | Action |
|---|---|---|
| No | Session | // Ignore requests from untrusted programmers. Ignore |
| Active | Initiation | repeated initiation requests. |
| Session | Request | if Programmer is trusted and |
| | | Session Initiation Pending not equal to |
| | | (Programmer, Mailbox Address) from Session Initiation |
| | | Request then |
| | | // Set up pending session. New initiation requests supplant |
| | | existing pending requests. |
| | | Set Session Initiation Pending to (Programmer, Mailbox |
| | | Address) |
| | | from Session Initiation Request. |
| | | Generate Pending Session Key. |
| | | Send Session Initiation Confirmation Request with Mailbox |
| | | Address from |
| | | Session Initiation Request and |
| | | Pending Session Key to Programmer Server. |
| | | Set Session Initiation Timeout Timer to Session Initiation |
| | | Timeout Constant. |
| | | endif |
| No | Session | if Session Confirmation Request is negative then |
| Active | Initiation | // Reset session initiation protocol. |
| Session | Confirmation | Set Session Initiation Pending to null. |
| | Response | Set Pending Session Key to null. |
| | | Clear Session Initiation Timeout Timer. |
| | | endif |
| No | Session | // Ignore invalid notifications. |
| Active | Ready | if Programmer from Session Ready Notification equals |
| | | Programmer from |
| | | Session Initiation Pending and |
| | | Session Key from Session Ready Notification equals |
| | | Pending Session Key then |
| | | // Convert pending session to active session. |
| | | Set Session Programmer to Programmer from Session |
| | | Initiation Pending. |
| | | Set Session Mailbox Address to Mailbox Address from |
| | | Session Initiation Pending. |
| | | Set Session Key to Pending Session Key. |
| | | Set Confirmation Configuration to null. |
| | | Set State to Active Session. |
| | | Send Configuration Request to Programmer Server. |
| | | Set Session Timeout Timer to Session Timeout Constant. |
| | | Clear Recent Confirmation Buffer. |
| Session | Notification | // Reset session initiation protocol. |
| | | Set Session Initiation Pending to null. |
| | | Set Pending Session Key to null. |
| | | Clear Session Initiation Timeout Timer. |
| | | endif |
| No | Confirmation | No action. |
| Active | Configuration | |
| Session | Response | |
| No | Confirmation | No action. |
| Active | Request | |
| Session | | |
| No | Session | No action. |
| Active | Keep-Alive | |
| Session | Request | |
| No | Session End | No action. |
| Active | Request | |
| Session | | |
| No | Session | // Reset session initiation protocol. |
| Active | Initiation | Set Session Initiation Pending to null. |
| Session | Timeout | Set Pending Session Key to null. |
| | | Clear Session Initiation Timeout Timer. |
| No | Session | No action. |
| Active | Timeout | |
| Session | | |
| Active | Session | Same as No Active Session case. |
| Session | Initiation | |
| | Request | |
| Active | Session | Same as No Active Session case. |
| Session | Initiation | |
| | Confirmation | |
| | Response | |
| Active | Session | Same as No Active Session case. |
| Session | Ready | |
| | Notification | |
| Active | Confirmation | // Accept only valid Confirmation Configurations. End |
| Session | Configuration | session if invalid. |
| | Response | if Confirmation Configuration in Confirmation |
| | | Configuration Response is valid then |
| | | Set Confirmation Configuration to Confirmation |
| | | Configuration in |
| | | Confirmation Configuration Response. |
| | | else |
| | | // End session. |
| | | Perform Session End Function with Invalid Confirmation |
| | | Configuration reason code. |
| | | end |
| Active | Confirmation | // Ignore invalid requests. |
| Session | Request | if (Programmer,Session Key) in Confirmation Request equal |
| | | Session Programmer and Session Key then |
| | | // Any message with a valid Session Key resets Session |
| | | Timeout Timer. |
| | | Set Session Timeout Timer to Session Timeout Constant. |
| | | if destination in Confirmation Request is in |
| | | DestinationTable in |
| | | Confirmation Configuration then |
| | | // Ignore requests that are duplicative or exceed rate limit. |
| | | Remove entries from Recent Confirmation Buffer older |
| | | than |
| | | Recent Confirmation Time Constant. |
| | | if Confirmation Request is not in Recent Confirmation |
| | | Buffer and |
| | | number of Confirmation Requests in Recent |
| | | Confirmation Buffer is fewer than |
| | | Recent Confirmation Limit Constant then |
| | | // Confirmation request is counted against limit even if |
| | | it fails. |
| | | Add (Current Time,Confirmation Request) to Recent |
| | | Confirmation Buffer. |
| | | // Issue confirmation. |
| | | Send (Programmer,Event) in Confirmation Request to |
| | | Destination Name in DestinationTable associated |
| | | with |
| | | Destination in Confirmation Request. |
| | | endif |
| | | endif |
| | | endif |
| Active | Session | // Ignore invalid requests. |
| Session | Keep-Alive | if (Programmer,Session Key) in Confirmation Request equal |
| | Request | Session Programmer and |
| | | Session Key then |
| | | Set Session Timeout Timer to Session Timeout Constant. |
| | | endif |
| Active | Session End | // Ignore invalid requests. |
| Session | Request | if (Programmer,Session Key) in Confirmation Request equal |
| | | Session Programmer and |
| | | Session Key then |
| | | // End session. |
| | | Perform Session End Function with Session End Request |
| | | reason code. |
| | | endif |
| Active | Session | // End session. |
| Session | Timeout | Perform Session End Function with Session Timeout reason |
| | | code. |
| Active | Session End | // End session. |
| Session | Function | Send (Session Mailbox Address,Session End Reason Code) |
| | | in Session End Notification to |
| | | Programmer Server. |
| | | Set Session Programmer to null. |
| | | Set Session Mailbox Address to null. |
| | | Set Session Key to null. |
| | | Set Confirmation Configuration to null. |
| | | Clear Session Timeout Timer. |
| | | Clear Recent Confirmation Buffer. |
| | | Set State to No Active Session. |

### Generate Session Key Function

The security of the TVOC system relies on attackers being unable to generate messages containing the session key associated with a pending or active session. It is therefore essential that the CTV TVOC function employ a secure method for generating session keys. The method can be resilient to attacks in the presence of the following threats:
1. Attacker has knowledge of the algorithm used to generate session keys by the CTV TVOC function
2. Attacker can observe a sequence of previously generated session keys from the CTV TVOC function instance

Note that standard random number generators are unsuitable for this task.

One possible approach to session key generation is to leverage the mature session key generation methods associated with the TLS connection established between the CTV and the Programmer Server. RFC 5705, available at https://www.rfc-editor.org/rfc/rfc5705 and incorporated herein by reference, (as amended by RFC 8446, available at_https://www.rfc-editor.org/rfc/rfc8446 and incorporated herein by reference) specify methods that enable devices with an active TLS connection to export shared keys. This feature is supported by OpenSSL, available at https://www.openssl.org/docs/manmaster/man3/SSL_export_keying_material.html and incorporated by reference. Note that IANA registration of a protocol “label” is expected for production systems that employ this mechanism (to avoid key reuse across applications) but implementations can be made using “experimental” labels.

### Streaming Media App Function

Video watermark technologies, such as the one specified in ATSC A/335, are available that: (a) can be added to the video output of a streaming media device video stream as a graphical overlay by a streaming media app; (b) are substantially invisible to a person watching the video output on a CTV; and (c) convey a message payload chosen by the streaming media app that is recoverable by the CTV through typical video equipment interfaces such as an HDMI connection. The HDMI interface is particularly amenable to carriage of low visibility watermarks between a streaming media player and a CTV, because it carries video data with “pixel accuracy”, allowing video watermarks to be detected even if their luminance embedding levels are extremely low.

The streaming media app can construct messages and periodically overlay them on their video output in accordance with the protocol given herein. ATSC A/335 standard is available at https://prdatsc.wpenginepowered.com/wp-content/uploads/2023/04/A335-2023-03-Video-Watermark-Emission.pdf and is incorporated herein by reference.

It is understood that the various embodiments of the present invention may be implemented individually, or collectively, in devices comprised of various hardware and/or software modules and components. These devices, for example, may comprise a processor, a memory unit, an interface that are communicatively connected to each other, and may range from desktop and/or laptop computers, to consumer electronic devices such as media players, mobile devices, and the like. For example, FIG. 1 illustrates a block diagram of a device 1000 within which the various disclosed embodiments may be implemented. The device 1000 comprises at least one processor 1002 and/or controller, at least one memory 1004 unit that is in communication with the processor 1002, and at least one communication unit 1006 that enables the exchange of data and information, directly or indirectly, through the communication link 1008 with other entities, devices and networks. The communication unit 1006 may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information.

Referring back to FIG. 1 the device 1000 and the like may be implemented in software, hardware, firmware, or combinations thereof. Similarly, the various components or sub-components within each module may be implemented in software, hardware, or firmware. The connectivity between the modules and/or components within the modules may be provided using any one of the connectivity methods and media that is known in the art, including, but not limited to, communications over the Internet, wired, or wireless networks using the appropriate protocols.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

1. A method for determining the state of a television in an HDMI system comprising:
receiving audiovisual content from an HDMI device through an HDMI cable, wherein data streams communicated received through the HDMI cable includes HDMI CEC messages;
analyzing the received HDMI CEC messages to determine if audiovisual content from an HDMI device is routed to a television;
analyzing the received HDMI CEC messages to determine if the television is powered on; and
taking a predetermined action based on the monitoring and analyzing.

2. The method of claim 1 further comprising sending a CEC command and analyzing the response to determine if the television is powered on.

3. The method of claim 1 wherein the monitoring is performed by a streaming media player device.

4. The method of claim 1 wherein the monitoring is performed by a device that is not a media player.

5. The method of claim 1 wherein the predetermined action comprises at least one of: sending an instruction to stop streaming, sending an instruction to start streaming, or sending an instruction to report stream viewing time.

6. The method of claim 1 further comprising inferring television source selection for a non-CEC source by using physical addresses.

7. The method of claim 1 further comprising resolving address conflicts by prioritizing certain messages over others to resolve ambiguities.

8. The method of claim 1 further comprising resolving address conflicts by ignoring irrelevant data.

9. The method of claim 1 further comprising inferring the television power state by eavesdropping on television messages and using the cessation of such messages to infer that the television has been turned off.

10. The method of claim 1 further comprising using separate estimations of TV source selection and TV power state.

11. (canceled)

12. The method of claim 1 further comprising using both Active Source and Routing Change messages to infer the value of fTVRenderingSMP indicating whether the TV is on and has a streaming media player (SMP) selected for display.

13-24. (canceled)

25. The method of claim 1 further comprising sending a CEC command and analyzing the response to determine if audiovisual content from an HDMI device is routed to a television.

26. The method of claim 1 wherein the predetermined action comprises reporting the likelihood that audiovisual content from an HDMI device is routed to a television.

27. The method of claim 1 further comprising tracking and prioritizing past parameter values of CEC messages.

28. A method for confirming in real-time that a connected television (CTV) is displaying content comprising:
receiving streamed content at a media player;
the media player rendering the streamed content and outputting it for display on a CTV;
the media player initiating a session with the CTV, using a session initiation protocol, wherein the session initiation protocol includes the streaming media app:
establishing a mailbox address that is uniquely associated with the media player;
augmenting the media content with a session initiation request watermark message that identifies the programmer server and mailbox address;
receiving from the programmer server a session key that has been delivered to the mailbox address by the CTV; and
augmenting the media content with a session ready notification watermark message that includes the session key.

29. The method of claim 28 wherein the mailbox address is uniquely associated with the media player.

30. The method of claim 28 wherein the mailbox address is established using a secure random number generator with a seed chosen to reduce the efficacy of a potential mailbox poisoning attack.

31. The method of claim 28 wherein the session initiation request watermark message identifies the programmer server in a data field that includes a registered hostname and identifies the watermark message as a session initiation request message by including one or more pre-defined values in additional watermark message data fields.

32. The method of claim 28 wherein the session ready notification watermark message identifies the programmer server in a data field that includes a domain name registered to the programmer making the request, and identifies the watermark message as a session ready message by including one or more pre-defined values in additional watermark message data fields.

33. The method of claim 28 wherein the media player is an HDMI source device.

34. The method of claim 28 wherein the media player comprises a streaming media app that is running on a media playback device and the session initiation and TV On Confirmation protocols are performed under control of the streaming media app.

35. The method of claim 28 wherein the media player comprises a media playback device that is running a streaming media app and the session initiation and TV On Confirmation protocols are performed under control of the media playback device.

36. The method of claim 28 wherein the programmer server is a broadband server under the control of a programmer.

37. A method for confirming in real-time that a connected television (CTV) is displaying streamed content received at a streaming media app in a media player comprising;
initiating a session between the CTV and the streaming media app using a session key;
the CTV requesting configuration information from the programmer server, the configuration information including a destination table and a mapping between destination field values and hostnames;
the CTV issuing a confirmation for each confirmation request that is from a trusted programmer and has a valid session key, wherein the received confirmation request is a TV on confirmation (TVOC) message specifying an event value and destination and wherein the TVOC message is contained in a video watermark payload; and
the CTV closing a current session in the event of one of: no valid messages received for a predetermine period of time, a new session initiation is completed, or a valid session end request TVOC message is received.

38. The method of claim 37 wherein the initiating comprises:
performing a session initiation protocol wherein:
the CTV detects a session initiation request watermark message in content that it is receiving and presenting, wherein the session initiation request watermark message identifies a programmer server and a mailbox address;
the CTV generates a session key;
the CTV sends a session initiation confirmation message to the programmer server, wherein the session initiation confirmation message includes the mailbox address and the session key;
the CTV receives confirmation from the programmer server that the mailbox address that the CTV provided is currently active and valid; and
the CTV detects a session ready notification watermark message in content that it is receiving and presenting, wherein the session ready notification message includes the session key.

39. The method of claim 38 wherein the session key is selected using a secure random number generator with a seed chosen to reduce the efficacy of a session key guessing attack by a fraudulent programmer or media player.

40. The method of claim 38 wherein the session initiation request watermark message identifies the programmer server in a data field that includes a registered hostname and identifies the watermark message as a session initiation request message by including one or more pre-defined values in additional watermark message data fields.

41. The method of claim 38 further comprising: the CTV determining whether or not to send a session initiation confirmation message to the programmer server only after a determination by the CTV that the particular programmer server that is identified in the session initiation confirmation message is a programmer server whose session initiation requests it will honor.

42. The method of claim 38 wherein the session ready notification watermark message identifies the programmer server in a data field that includes a domain name registered to the programmer making the request, and identifies the watermark message as a session ready message by including one or more pre-defined values in additional watermark message data fields.

43. The method of claim 38 wherein the CTV comprises a downloaded application that is running on a media presentation device and the session initiation and TV On Confirmation protocols are performed under control of the downloaded application.

44. The method of claim 38 wherein the CTV comprises a downloaded application that is running on a media presentation device and the session initiation and TV On Confirmation protocols are performed under control of the media presentation device.

45. The method of claim 38 wherein the CTV comprises a downloaded application that is running on a media presentation device and the watermark detection function is performed under control of the media presentation device and the remainder of the session initiation and TV On Confirmation protocols are performed under control of the downloaded application.

46. The method of claim 38 wherein the programmer server is a broadband server under the control of a programmer.

47. The method of claim 38 further comprising the CTV retiring the session key after closing the current session.

48. The method of claim 28 wherein the TV On Confirmation (TVOC) watermark message further includes a destination value.

49. The method of claim 48 further comprising:
after a session has been initiated, the media player requesting issuance of a confirmation by augmenting the media content with a TV On Confirmation (TVOC) watermark message that includes the session key and an event value.
